(19) United States
(12) Patent Application Publication
(10) Pub. No.: US 2024/0414397 A1
(43) Pub. Date: Dec. 12, 2024

(54) METHOD AND SYSTEM FOR REAL-TIME CONTENT GENERATION BASED ON BIOMETRIC FEEDBACK

(71) Applicant: Sir Koko, LLC, Las Vegas, NV (US)

(72) Inventor: Robertson Price, Philadelphia, PA (US)

(73) Assignee: Sir Koko, LLC, Las Vegas, NV (US)

(21) Appl. No.: 18/330,111

(22) Filed: Jun. 6, 2023

(51) Int. Cl. H04N 21/442; H04N 21/238

(52) U.S. Cl. CPC H04N 21/44218; H04N 21/238

(57) ABSTRACT

The process may include receiving a content request. The content request may include a content characteristic preference. The process may include generating a first content stream segment. The first content stream segment may include a first characteristic quality. The process may also include outputting the first content stream segment via a playback device, and the process may include receiving biometric data regarding a user perceiving the output. The process may also include identifying a characteristic modification. The process may further include generating a second content stream segment. The second content stream segment may have a second characteristic quality. The second characteristic quality may be the result of applying the characteristic modification to the first characteristic quality. The process may further include outputting the second content stream segment on the playback device such that the first and the second segments may be perceived by the user as a continuous content stream.

### FIELD OF THE INVENTION

The present invention relates to computer-implemented systems and methods for generating and performing content responsive to biometric data in real-time.

### BACKGROUND OF THE INVENTION

There are numerous options and mediums from which people are able to view and receive content for the purpose of entertainment, education, relaxation, adult entertainment, etc. However, a common issue is that the content is not limitless. This often leads consumers to become frustrated or turn to alternative options or sources of content as a replacement. Also, a common issue with content that is a constant struggle for content providers is that the content may not engage the viewer and/or user to continue viewing or using the content. This is either because the consumer is either disinterested in the content, or the content itself has failed to captivate the consumer. Lastly, a growing issue due to the numerous content providers and varieties of content available to consumers in recent years is that a consumer may want to be educated, entertained, or relaxed by viewing some content, but struggles to find the precise content the most or preferably satisfies the consumer's preferences, or the consumer may be unsure what content that he or she is specifically looking for.

Thus, there exists a need in the prior art for a source and production of content that is capable of nearly limitless content, is capable of captivating a consumer, and is able to provide the content type or variety that the consumer is in want for. This need is provided for by the present invention by automatically generating content in real-time or near real-time on the topic of the consumer's content choice, and also continually changing the characteristics of the content generated in real-time with reference to biometric feedback data collected and/or detected from a consumer that is viewing the content in order to ensure the content generated is as ideal as possible for the consumer by keeping the consumer engaged and providing content that is the most fitting for the consumer. Moreover, in contexts where the viewer is non-human (e.g. animals, plants, or other life forms) and unable to provide intentional feedback regarding the content they are consuming, measuring physiological responses can provide an opportunity for tailoring generated content without requiring intentional feedback.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a device for generating and performing content responsive to biometric data. The device may include at least one processor. The processor may be configured to receive a content request from a user or person directing the content to be generated. The content request may include a content characteristic preference. The processor may be configured to generate a first content stream segment, the generation of which may be responsive to the content characteristic preference. The first content stream segment may have a first characteristic quality.

The processor may be configured to output the first content stream segment via a playback device and may be configured to receive biometric data that may regard a user perceiving the output of the first segment on the playback device which may be received from at least one user monitor device. The processor may further be configured to identify a characteristic modification to the first characteristic quality, the identification of which may be responsive to the biometric data.

The processor may be yet further configured to generate a second content stream segment, the generation of which may be responsive to each of the content characteristic preference and/or the biometric data in real-time. The second content stream segment may have a second characteristic quality. The second characteristic quality may be the result of applying the characteristic modification to the first characteristic quality. The processor may be configured to output the second content stream segment on the playback device, which may be such that the playback of the first content stream segment and the second content stream segment by the playback device may be perceived by the user as a continuous content stream.

At least one processor may be further configured to receive an output parameter selection from a user selecting an output parameter from a listing of output parameters. The output parameter listing may include volume, brightness, speed, data privacy, network connectivity, age restrictions, religious preferences, cultural sensitivity, strobe lighting effects, heart or stress preferences, time limit, language preferences, content rating (violence, suspense, horror, nudity, explicit language), personal health conditions (such as epilepsy or photosensitivity), color blindness considerations, hearing impairment considerations, accessibility settings, cognitive load preferences, content duration, user interaction requirements, and/or other controls governing substantially all content characteristics. The processor may be configured to compile a user record associated with the user, which may be based upon the content characteristic preference, the first content stream segment, the biometric data, the characteristic modification, the second content stream segment, the second characteristic quality, and/or the continuous content stream.

The processor may be configured to broadcast the user record to a database of user records to have the user record indexed with a library of user records in the database of user records. The processor may be further configured to receive the user record associated with the user from the library of user records in the database of user records. The processor may yet be further configured to output a sensory stimulation signal that is associated with at least one of the first content stream segment and the second content stream segment to be received by at least one sensory stimulation device. The sensory stimulation device may be configured to take a sensory stimulation action based on the sensory stimulation signal received.

The sensory stimulation action taken by the at least one sensory stimulation device may include causing a sensation of at least one of vision, hearing, smell, taste, touch, balance, proprioception, temperature, or pain by the user. The biometric data may include attributes of the user. The attributes of the user may comprise the user's blood pressure, heart rate, heart rate variability (HRV), body temperature, skin temperature, flushing of skin, electrodermal activity (EDA), perspiration, breathing pattern, body movement, eye movement, facial expression, audible sound, brain activity, oxygen saturation, hydration level, blood glucose level, hormone levels, sleep patterns, gait analysis, pupil dilation, vocal characteristics, muscle tension, pain response, smell or pheromone detection, and/or genetic markers. The brain activity of the user may include the electrical activity of the brain of the user which may define gamma waves, beta waves, alpha waves, theta waves, and/or delta waves. Other neurological signals such as event-related potentials (ERPs), magnetoencephalography (MEG) signals, and/or near-infrared spectroscopy (NIRS) data may also be considered.

The at least one user monitor device may comprise a heart monitor, blood pressure monitor, body temperature monitor, skin temperature monitor, electrodermal activity monitor, perspiration monitor, breathing monitor, motion monitor, eye tracker, facial expression recognition system, sound analysis device, brain activity monitor (including devices for electroencephalography (EEG), magnetoencephalography (MEG), and near-infrared spectroscopy (NIRS)), oxygen saturation monitor, hydration monitor, blood glucose monitor, hormone level monitor, sleep monitor, gait analysis device, pupil dilation monitor, voice analysis device, muscle tension monitor, pain response monitor, smell or pheromone detection device, genetic marker analysis tool, and/or any other device capable of measuring physiological and/or behavioral biometrics. This includes not only cameras and microphones, but also specialized sensors and devices developed for medical, psychological, or biological research and monitoring. The listing of content types may include entertainment, relaxation, education, meditation, health, wellness, therapeutic, relationship, sexual, survival, safety, nutritional, communication, physical activity, exercise, environmental interaction, social, behavioral, sensory stimulation, parenting, offspring care, creativity, problem solving, and custom or miscellaneous content. The playback device may include, but is not limited to, a visual display device, an audio generating device, a tactile or haptic stimulation device, an olfactory stimulation device, a gustatory stimulation device, a thermoregulatory stimulation device, a vestibular stimulation device, an electromagnetic stimulation device, a pain stimulation device, a kinesthetic stimulation device, a light stimulation device, an ultrasonic stimulation device, a pressure stimulation device, and/or a vibrational stimulation device.

The content request may be received in the form of a selection of a content types from a list of content types. The selection may define the content characteristic preference. The content request may be received in the form of a natural language request from the user. The processor may be configured to parse the natural language request, analyze the parsed natural language request to determine a user intent, and/or identify the content characteristic preference from the user intent. Identifying the content characteristic preference from the user intent may comprise matching the user intent with a content type from a list of content types that is most closely related to the user intent or by examining previous user inputs or selections to further inform user intent.

In some embodiments of the present invention the biometric data may define a first biometric data set related to a first user perceiving the first content stream segment. The processor may be further configured to receive a second biometric data set regarding a second user perceiving the output of the first segment on the playback device. Identifying the characteristic modification to the first characteristic quality may be responsive to the first biometric data set and the second biometric data set. Generating the second content stream segment may be responsive to each of the content characteristic preference, the first biometric data set, and the second biometric data set.

The processor may be yet further configured to receive a weighting value for each of the first user and the second user. Identifying the characteristic modification to the first characteristic quality may be responsive to the first biometric data set weighted by the weighting value of the first user and the second biometric data set weighted by the weighting value of the second user. In some embodiments of the present invention the processor may be configured to identify a weighting value for each of the first user and the second user. Identifying the characteristic modification to the first characteristic quality may be responsive to the first biometric data set weighted by the weighting value of the first user and the second biometric data set weighted by the weighting value of the second user.

Now a method aspect of the present invention may be described for a process for using a device for real-time or near real-time content generation informed by biometric feedback. The process may include receiving a content request from a user. The content request may include comprising a content characteristic preference. The process may further include generating a first content stream segment, the generation of which may be responsive to the content characteristic preference. The first content stream segment may include a first characteristic quality. The process may yet further include outputting the first content stream segment via a playback device and may include receiving biometric data regarding a user perceiving the output of the first segment from the playback device, which may be received from at least one user monitor device.

The process may also include identifying a characteristic modification to the first characteristic quality, the identification of which may be responsive to the biometric data. The process may further include generating a second content stream segment, the generation of which may be responsive to each of the content characteristic preference and the biometric data in real-time. The second content stream segment may have a second characteristic quality. The second characteristic quality may be the result of applying the characteristic modification to the first characteristic quality. The process may yet further include outputting the second content stream segment on the playback device such that the playback of the first content stream segment and the second content stream segment by the playback device may be perceived by the user as a continuous content stream.

In some embodiments the process may include receiving an output parameter selection from a user selecting an output parameter from a listing of output parameters. The output parameter listing may include volume, brightness, speed, data privacy, network connectivity, age restrictions, religious preferences, cultural sensitivity, strobe lighting effects, heart or stress preferences, time limit, language preferences, content rating (violence, suspense, horror, nudity, explicit language), personal health conditions (such as epilepsy or photosensitivity), color blindness considerations, hearing impairment considerations, accessibility settings, cognitive load preferences, content duration, user interaction requirements, and/or other controls governing substantially all content characteristics. In some embodiments the process may include compiling a user record associated with the user and based upon the content characteristic preference, the first content stream segment, the biometric data, the characteristic modification, the second content stream segment, the second characteristic quality, and/or the continuous content stream.

In other embodiments the process may include broadcasting the user record to a database of user records, and indexing the user record with a library of user records in the database of user records. The process may also comprise receiving the user record associated with the user from the library of user records in the database of user records. In other embodiments the process may include outputting a sensory stimulation to the user that may be associated with at least one of the first content stream segment and/or the second content stream segment. The sensory stimulation may include a sensation of vision, hearing, smell, taste, touch, balance, proprioception, temperature, or pain by the user.

The biometric data may include attributes of the user. The attributes of the user may comprise the user's blood pressure, heart rate, heart rate variability (HRV), body temperature, skin temperature, flushing of skin, electrodermal activity (EDA), perspiration, breathing pattern, body movement, eye movement, facial expression, audible sound, brain activity, oxygen saturation, hydration level, blood glucose level, hormone levels, sleep patterns, gait analysis, pupil dilation, vocal characteristics, muscle tension, pain response, smell or pheromone detection, and/or genetic markers. The brain activity of the user may include the electrical activity of the brain of the user which may define gamma waves, beta waves, alpha waves, theta waves, and/or delta waves. Other neurological signals such as event-related potentials (ERPs), magnetoencephalography (MEG) signals, and/or near-infrared spectroscopy (NIRS) data may also be considered.

The at least one user monitor device may comprise a heart monitor, blood pressure monitor, body temperature monitor, skin temperature monitor, electrodermal activity monitor, perspiration monitor, breathing monitor, motion monitor, eye tracker, facial expression recognition system, sound analysis device, brain activity monitor (including devices for electroencephalography (EEG), magnetoencephalography (MEG), and near-infrared spectroscopy (NIRS)), oxygen saturation monitor, hydration monitor, blood glucose monitor, hormone level monitor, sleep monitor, gait analysis device, pupil dilation monitor, voice analysis device, muscle tension monitor, pain response monitor, smell or pheromone detection device, genetic marker analysis tool, and/or any other device capable of measuring physiological and/or behavioral biometrics. This includes not only cameras and microphones, but also specialized sensors and devices developed for medical, psychological, or biological research and monitoring. The listing of content types may include entertainment, relaxation, education, meditation, health, wellness, therapeutic, relationship, sexual, survival, safety, nutritional, communication, physical activity, exercise, environmental interaction, social, behavioral, sensory stimulation, parenting, offspring care, creativity, problem solving, custom or miscellaneous. The playback device may include, but is not limited to, a visual display device, an audio generating device, a tactile or haptic stimulation device, an olfactory stimulation device, a gustatory stimulation device, a thermoregulatory stimulation device, a vestibular stimulation device, an electromagnetic stimulation device, a pain stimulation device, a kinesthetic stimulation device, a light stimulation device, an ultrasonic stimulation device, a pressure stimulation device, and/or a vibrational stimulation device.

In some embodiments the content request may be received in the form of a selection of a content type from a list of content types, and the selection may define the content characteristic preference. In some embodiments the content request may be received in the form of a natural language request from the user. The process may also include parsing the natural language request, analyzing the parsed natural language request to determine a user intent, and identifying the content characteristic preference from the user intent. Identifying the content characteristic preference from the user intent may include matching the user intent with a content type from a list of content types that may be most closely related to the user intent or by examining previous user inputs or selections to further inform user intent.

In some embodiments the biometric data may define a first biometric data set related to a first user perceiving the first content stream segment. The process may further include receiving a second biometric data set regarding a second user perceiving the output of the first segment on the playback device. Identifying the characteristic modification to the first characteristic quality may be responsive to the first biometric data set and the second biometric data set. Generating the second content stream segment may be responsive to each of the content characteristic preference, the first biometric data set, and the second biometric data set.

In some embodiments the process may include receiving a weighting value for each of the first user and the second user. Identifying the characteristic modification to the first characteristic quality may be responsive to the first biometric data set weighted by the weighting value of the first user and the second biometric data set weighted by the weighting value of the second user. In some embodiments the process may include identifying a weighting value for each of the first user and the second user. Identifying the characteristic modification to the first characteristic quality may be responsive to the first biometric data set weighted by the weighting value of the first user and the second biometric data set weighted by the weighting value of the second user.

### BRIEF DESCRIPTION OF THE DRAWINGS

Some embodiments of the present invention are illustrated as an example and are not limited by the figures of the accompanying drawings, in which like references may indicate similar elements.

FIG. 1A is a flowchart illustration of method aspects of an embodiment of the present invention.

FIG. 1B is a continuation of the flowchart of FIG. 1A illustrating further aspects of an embodiment of the present invention.

FIG. 2 is a schematic illustration of a database, network, and a device according to an embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

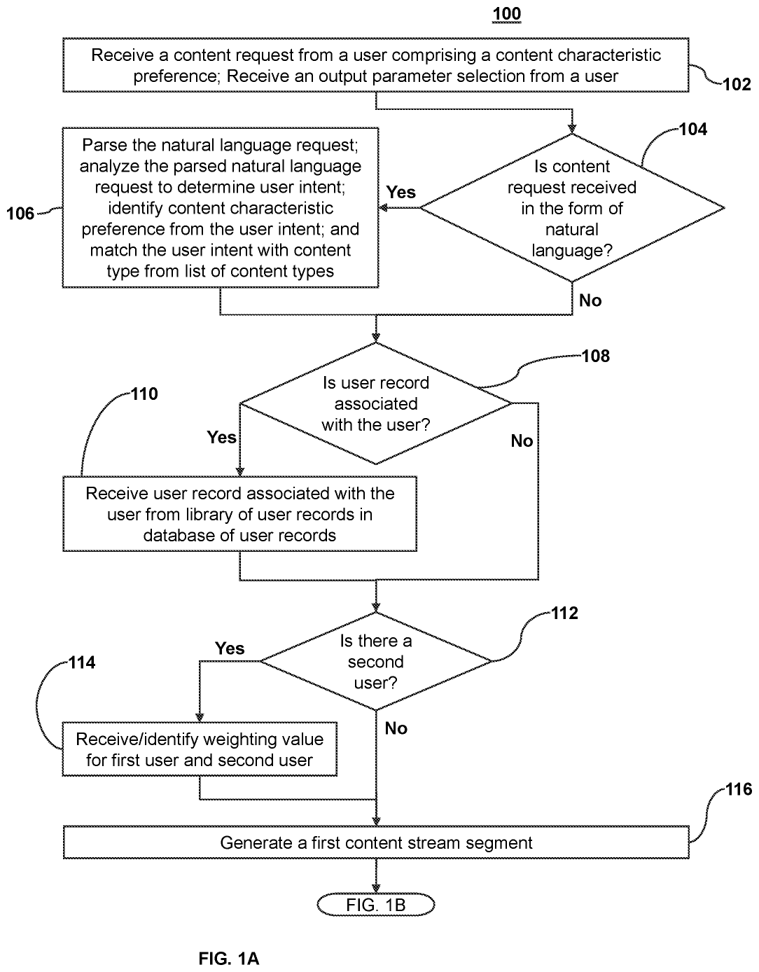

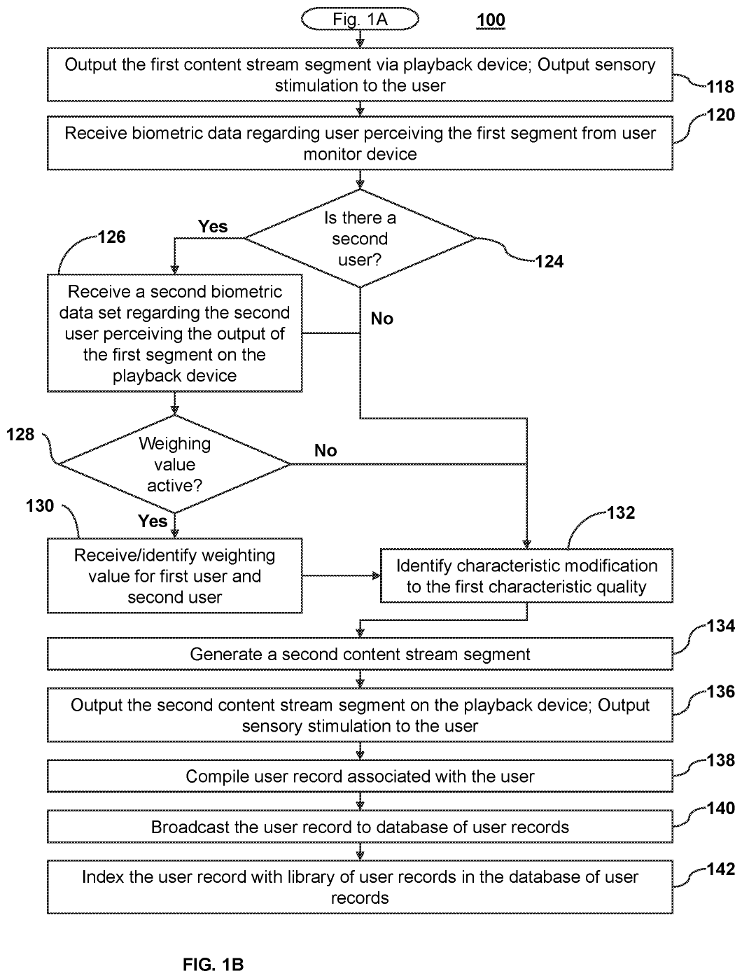

An embodiment of the invention, as shown and described by the various figures and accompanying text, provides a method and system for generating and performing content, the generation of which may be responsive to biometric data. FIGS. 1A-1B are a flowchart of an exemplary process 100. In some implementations, one or more process blocks of FIGS. 1A-1B may be performed by a device 200.

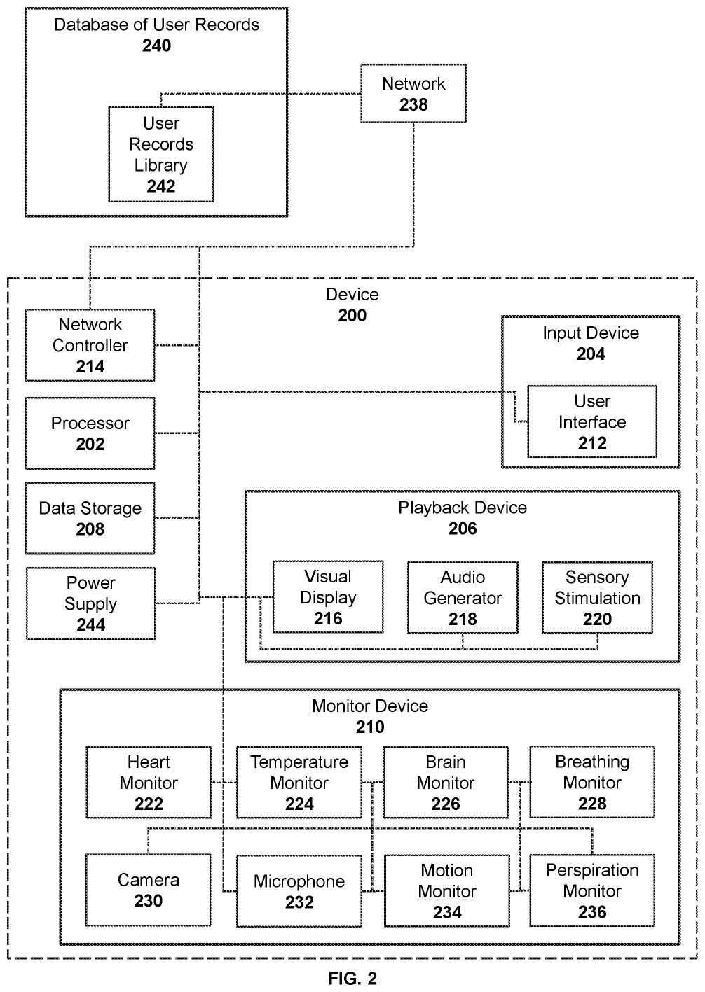

Initially referring to FIG. 2, the device 200 may include one or more processors 202, at least one input device 204, at least one playback device 206, and at least one monitor device 210. The processor 202 may be in communication with an input device 204 and a monitor device 210. The processor may be any computer processing device as is known in the art, including, but not limited to, microprocessors, integrated circuits, field programmable gate arrays, and the like. The processor 202 may be configured to receive a content request from a user. The content request may include a content characteristic preference, and the content request may be sent to the processor 202 by the user selecting and/or inputting the content request via interacting with the input device 204 or the monitor device 210.

Some embodiments of the present invention may include the processor 202 being configured to receive a content request in the form of a natural language, e.g., text written in natural language, spoken audible words, or other sounds. The processor 202 may receive the natural language content request via one of a user interface 212 comprised by the input device 204 and a microphone 232 detecting the natural language content request made by a user. The processor 202 may be configured to parse the natural language request and analyze the parsed natural language request to determine the intent of the user, which may define a user intent. The processor 202 may be further configured to identify the content characteristic from the user intent. In some embodiments of the present invention, the processor 202 may be configured to identify the content characteristic preference from the user intent by matching the user intent with a content type from a list of content types, with the user intent being matched with the content type in the list of content types that is most closely related to the user intent.

The processor 202 may be configured to generate a first content stream segment that may be responsive to the content characteristic preference of the content request and/or the user intent. The generation of content stream segments by the processor 202 may be by artificial intelligence (AI) processing, such that the content stream segments are not pre-chosen or pre-made and are instead actively generated in real-time or nearly in real-time by the processor 202. The generation of the content stream segments may be AI generated with reference to, or responsive to, the content request, the content characteristic preference, and/or biometric data. Details on the content characteristic preference and the biometric data follows further below.

The content request may include a topic, genre of entertainment, emotional state, historical period, artwork, any entertainment piece, motion picture, photograph, literary work, fantasy genre, any work of authorship, and any other work that can be in a medium of exchange that can be interpreted or understood in a computer readable format by the processor 202. For example, and without limitation, the content type request may comprise one or more of entertainment, relaxation, education, meditation, health, wellness, therapeutic, relationship, sexual, survival, safety, nutritional, communication, physical activity, exercise, environmental interaction, social, behavioral, sensory stimulation, parenting, offspring care, creativity, problem solving, and custom or miscellaneous content, and combinations thereof. The processor 202 may reference the content request to conform, shape, match, and/or align the generation of the content stream segment(s) to that content request.

The content stream segment may include a characteristic quality. The characteristic quality may define characteristics of the content stream segment, which may include, but are not limited to, color scheme, pace, intensity, language, dialect, genre, sub-genre, topic, subtopic, complexity, detail level, associated recommended viewer age, length of story arc, narrative style, historical accuracy, scientific accuracy, cultural context, moral or ethical themes, sensory modality used, level of interactivity, degree of personalization, narrative perspective, emotional tone, level of realism or fantasy, pacing of plot development, character complexity, background music or sound effects, visual aesthetics, level of suspense or conflict, resolution style, humor style, educational content, and any other descriptor or guideline that may be associated with the content stream segment which may also be associated with the content request. It is further contemplated and included within the scope of the invention that the content stream segment may include a plurality of characteristic qualities.

The processor 202 may transmit the content stream segment to at least one playback device 206. The playback device 206 may receive the content stream segment and output the content stream segment in the form of audio, visual, and/or other sensory stimulation. The playback device 206 may include one or more of a visual display device 216, an audio generating device 218, and a sensory stimulation device 220.

The visual display device 216 may output and/or emit a visual representation of a content stream segment received by the visual display device 216, the visual representation being perceptible by a user. The visual display device 216 may comprise a stationary display, a mobile display, a visual projector, a virtual-reality (VR) headset, a VR projector in three-dimensional (3D) space, a light stimulation device, and/or any other visual output device that may generate visual stimuli that may be perceptible by the user as understood by those skilled in the art.

The audio generating device 218 may output and/or emit an audio representation of a content stream segment received by the audio generating device 218, the audio representation may be perceptible by a user. The audio generating device 218 may comprise one or more of a speaker, headset, headphone, audio implant that allows a user to comprehend audio, ultrasonic stimulation device and/or any other audio stimulation device that may allow a user to hear or perceive sound as understood by those skilled in the art.

The sensory stimulation device 220 may generate, output, or emit sensory stimulation that may be associated with a content stream segment that is received by the sensory stimulation device 220. The sensory stimulation by the sensory stimulation device 220 may be sensed by one of a user's senses. Such as, and without limitation, the sensory stimulation generated, outputted, or emitted by the sensory stimulation device 220 may include tactition (touch, friction, vibration, pressure, and physical manipulation), thermoception (presence of cold/absence of heat, presence of warmth/heat, and temperature change), nociception (sensations of pain), equilibrioception (perception of balance and orientation), proprioception (person's sense of location for each of his/her body parts), physical sensation (gravity, wind, motion, moisture, absence of moisture, electric shock), olfactory (smell), and/or gustation (taste).

The sensory stimulation device 220 may comprise a tacitition device, a termoception device, a nociception device, a proprioception device, a physical sensation device, an olfactory device, and/or a gustation device, a vestibular device, an electromagnetic stimulation device, a pressure stimulation device, and/or a vibrational stimulation device that may each be configured to be worn, equipped, or carried by a user and each may alternatively be positioned adjacent to or in proximity to a user of the device 200.

Embodiments of the present invention may include a monitor device 210. The monitor device 210 may be configured to detect, monitor, and/or sense one or more biometric data that may be regarding biometric attributes of a user that is using the device 200. The monitored biometric data and/or attributes of a user may include the user's blood pressure, heart rate, heart rate variability (HRV), body temperature, skin temperature, flushing of skin, electrodermal activity (EDA), perspiration, breathing pattern, body movement, eye movement, facial expression, audible sound, brain activity, oxygen saturation, hydration level, blood glucose level, hormone levels, sleep patterns, gait analysis, pupil dilation, vocal characteristics, muscle tension, pain response, smell or pheromone detection, and/or genetic markers. The brain activity of the user may include the electrical activity of the brain of the user which may define gamma waves, beta waves, alpha waves, theta waves, and/or delta waves. Other neurological signals such as event-related potentials (ERPs), magnetoencephalography (MEG) signals, and/or near-infrared spectroscopy (NIRS) data may also be considered. The monitor device 210 may be in communication with the processor 202, and the monitor device 210 may be configured to send a biometric data signal associated with the monitored biometric data of the user. The biometric data signal may be sent by the monitor device 210 to the processor 202 on a constant and/or periodic basis. Further details on the monitor device 210 follow further below.

The processor 202 may receive the biometric data signal, interpreting and associating the biometric data with either the entirety or a fraction of a content stream segment, as well as the corresponding characteristic quality of the segment as perceived by the viewer via one or more playback devices 206. The processor 202 may also determine characteristic modifications in response to the associated biometric data. In some embodiments, the content request might elicit a specific intended physiological response. Certain types of content may be associated with desired physiological responses. For example, meditation content may have a desired physiological response of at least one of a reduction in heart rate, a reduction in blood pressure, a reduction in HRV, a reduction in respiration rate, a reduction in body and/or eye movement, and a change in brain wave patterns, including changes to at least one of delta waves, theta waves, alpha waves, beta waves, and gamma waves. Such physiological responses may be measured as biometric data measured by the monitor device 210. Different content types are associated with varying intended physiological responses. If the intended physiological response does not manifest as per the biometric data, the processor 202 is programmed to identify and enact a characteristic modification. This modification is intended to generate a content stream that, when perceived by the viewer, triggers a different physiological response.

The processor 202 may yet further be configured to generate another content stream segment (which may be referred to as a second content stream segment, or a following content stream segment, with the prior content stream segment being referred to as the first content stream segment, or the previous content stream segment). The generation of the following content stream segment by the processor 202 may be responsive to the content characteristic preference and the biometric data of the biometric signal, which may be generated by the processor 202 in real-time or near real-time.

The following content stream segment, like the previous content stream segment from which the following content stream segment was generated, may include a characteristic quality as defined further above (i.e., a second characteristic quality or a following characteristic quality). However, the following characteristic quality of the following content stream segment may be the result of the processor 202 applying the characteristic modification to the characteristic quality of the previous content segment.

The processor 202 may further be configured to output the following content stream segment to the one or more playback devices 206 for the playback devices 206 to generate, emit, and/or output the visual, audio, and/or sensory stimulation that may be associated with the following content stream segment, which may be such that the playback of the previous content stream segment and the following content stream segment are perceived by the user as a continuous content stream.

In some embodiments of the present invention, the input device 204 may be operable by a user to select an output parameter, which may be from a listing of output parameters. Upon a user selecting an output parameter with the input device 204, the input device 204 may send an output parameter signal associated with the selected output parameter to the processor 202. The output parameter listing may include volume, brightness, speed, data privacy, network connectivity, age restrictions, religious preferences, cultural sensitivity, strobe lighting effects, heart or stress preferences, time limit, language preferences, content rating (violence, suspense, horror, nudity, explicit language), personal health conditions (such as epilepsy or photosensitivity), color blindness considerations, hearing impairment considerations, accessibility settings, cognitive load preferences, content duration, user interaction requirements, academic difficulty of the content, and/or other controls governing substantially all content characteristics.

Upon the processor 202 receiving the output parameter signal, the processor 202 may take a respective action associated with the output parameter signal received. For example, and without limitation, upon the processor 202 receiving an output parameter signal, the processor 202 may cause a content stream segment to increase or decrease playback speed, cause the playback device(s) 206 to increase or decrease audio volume, cause the playback device(s) 206 to increase or decrease the brightness, contrast, or saturation of the playback of a content stream segment, set a time limit on the content stream segments generated by the processor 202, cause a network controller 214 to connect or disconnect to a network 238, or cause the network controller 214 to restrict user data and biometric data from being transmitted over the network 238. As another example, and also without limitation, upon the processor 202 receiving an output parameter signal, the processor 202 may cause a content stream segment increase or reduce the degree of intensity of violence, gore, or fear-inducing content responsive to the output parameter signal and/or the received biometric data. The preceding examples are non-limiting and modifying the generation of content stream segments along any of the output parameters is contemplated and included within the scope of the invention.

In some embodiments of the present invention, the processor 202 may be configured to compile a user record associated with a user that is operating the device 200. The user record may include the content characteristic preference, the content stream segment(s), the biometric data of the user, the characteristic modification(s) of the content stream segment(s), and the continuous content stream generated by the processor 202 for the user. The processor 202 may further be configured to broadcast the user record to a database of user records 240. The processor 202 may broadcast the user record to the database 240 via a network controller 214 and/or a network 238.

The database of user records 240 may receive the user record from the processor 202, and the database 240 may index the user record, which may be indexed with a library of user records 242 within the database 240. In some embodiments of the present invention, the processor 202 may be configured to receive a user record that is associated with a user operating the device 200, which may be received from the database of user records 240 and/or the library of user records 242, and which may be received via the network controller 214 and/or the network 238. The processor 202 may be configured to additionally generate content stream segments responsive to the user record associated with the user. The processor 202 may further be configured to identify a characteristic modification to a characteristic quality of a content stream segment, and further responsive to the user record associated with the user.

Continuing to refer to FIG. 2, embodiments of the present invention may include one or more monitor devices 210 which may be in communication with the processor 202. The monitor device(s) 210 may be configured to sense, detect, and/or monitor biometric data regarding a user of the device 200. The biometric data regarding the user may include the user's blood pressure, heart rate, heart rate variability (HRV), body temperature, skin temperature, flushing of skin, electrodermal activity (EDA), perspiration, breathing pattern, body movement, eye movement, facial expression, audible sound, brain activity, oxygen saturation, hydration level, blood glucose level, hormone levels, sleep patterns, gait analysis, pupil dilation, vocal characteristics, muscle tension, pain response, smell or pheromone detection, and/or genetic markers. The brain activity of the user may include the electrical activity of the brain of the user which may define gamma waves, beta waves, alpha waves, theta waves, and/or delta waves. Other neurological signals such as event-related potentials (ERPs), magnetoencephalography (MEG) signals, and/or near-infrared spectroscopy (NIRS) data may also be considered. The monitor device 210 may be configured to send a biometric data signal associated with the monitored biometric data of the user. The biometric data signal may be sent by the monitor device 210 to the processor 202 on a constant and/or periodic basis.

The monitor devices 210 may comprise one or more of a heart monitor 222, such as one of a pulseoximetry device and an electrocardiographic (EKG) device, a temperature monitor 224, a brain monitor 226 such as an electroencephalographic (EEG) device, a breathing monitor 228, a camera 230, a microphone 232, a motion monitor 234, and/or a perspiration monitor 236. The heart monitor 222 may be positioned in physical contact with a user of the device 200, and/or the heart monitor 222 may be positioned in proximity to a user. The heart monitor 222 may be configured to sense, detect, and/or monitor the user's blood pressure, heart rate, and/or heart rate variability (HRV). The heart monitor 222 may comprise a blood pressure monitor, a heart rate monitor, HRV monitor, and/or any other monitor configured to measure blood pressure, heart rate, and/or HRV that can be used as the heart rate monitor 222 as understood by those skilled in the art.

The temperature monitor 224 may be positioned in physical contact with a user of the device 200, or the temperature monitor 224 may be positioned in proximity to a user of the device 200. The temperature monitor 224 may be configured to sense, detect, and/or monitor the temperature of a user (including internal core temperature, skin surface temperature, and/or a temperature mapping of a user's body), including the present temperature of the user and temperature changes of the user. The temperature monitor 224 may comprise a thermocouple sensor, a thermistor sensor, a resistance temperature detector, a thermometer, an infrared temperature sensor, a semiconductor-based temperature sensor, and/or any other temperature sensor that may be used as the temperature monitor 224 as understood by those skilled in the art.

The breathing monitor 228 may be positioned in physical contact with a user of the device 200 or may be positioned in proximity to the user of the device 200. The breathing monitor 228 may be configured to sense, detect, and monitor the breathing of a user of the device 200, which may include sensing the expansion and contraction of the user's abdomen and/or the movement of air flow in and out from the user's mouth and/or nostrils.

The microphone 232 may be positioned in physical contact with a user of the device 200, or may be positioned in proximity to the user of the device 200. The microphone 232 may be configured to sense audible noise caused by a user. The microphone 232 may be configured to transform and/or convert the audible noise caused by a user to a computer readable format. In some embodiments, intentional feedback indicating the user's preferences on the already perceived content segment can be included in the feedback. In such embodiments, spoken feedback may be parsed, analyzed for sentiment, and utilized by the processor 202 in generating a subsequent streaming content segment. While not received by the microphone 232, it is contemplated and included within the scope of the invention that receiving the user's intentional feedback by any medium, including user input devices such as keyboards, mice, touchscreens, and the like, may be utilized in generation of subsequent streaming content segments.

The motion monitor 234 may be configured to be carried by a user of the device 200, and/or the motion monitor 234 may be configured to be positioned in proximity to a user of the device 200. The motion monitor 234 may further be configured to track, sense, detect, and/or monitor physical the physical position and physical motion of a user's person, which may include the movement of the user's body and any physical matter carried thereby or extending therefrom. The motion monitor 234 may comprise an optical sensor, an inertial sensor, mechanical motion sensor, magnetic motion sensor, and/or any other optical or non-optical motion sensor that may be used as the motion monitor 234 as understood by those skilled the art.

The perspiration monitor 236 may be configured to be carried by a user of the device 200, and/or the perspiration monitor 236 may be configured to be positioned in proximity to a user of the device 200. The perspiration monitor 236 may be configured to sense, detect, track, and/or monitor perspiration of a user operating the device 200. The perspiration monitor 236 may comprise a skin-contact wearable perspiration sensor, a near-skin perspiration sensor, an optical perspiration sensor, or any other sensor configured to detect and monitor perspiration of a user that can be used as the perspiration monitor 236 as understood by those skilled in the art.

The brain monitor 226 may be shaped and configured to be worn by a user, and/or the brain monitor 226 may be configured to be positioned in proximity to a user that is using the device 200. The brain monitor 226 may be configured to sense, detect, read, interpret, and/or monitor brain activity and electrical activity of a brain. The brain activity read, interpreted, and monitored by the brain monitor 226 may include the gamma waves, beta waves, alpha waves, theta waves, or delta waves of a brain.

The camera 230 may be configured to be positioned at a fixed location relative to the processor 202, and the camera 230 may be configured to move in up to three degrees of motion and/or be configured to rotatably move about an axis. In some embodiments of the present invention, the camera 230 may be configured to be worn by a user, which may be worn and positioned in near proximity to a user's eye(s). Some embodiments of the present invention may include one or more cameras 230, such as, and without limitation, three cameras 230. The camera 230 may be configured to optically record, sense, track, detect, and/or interpret facial expressions, eye characteristics, and/or eye movement and directional positioning.

Facial expressions detected, monitored, and interpreted by the camera 230 may include, without limitation, surprise, fear, happiness, disgust, excitement, anger, anticipation, sadness, disinterest, inattention, fatigue, arousal, love, amusement, love, anxiety, contempt, awe, relaxation, confusion, interest, embarrassment, or any other facial expression as understood by those skilled in the art. Eye characteristics detected, monitored, and interpreted by the camera 230 may include relative eyelid position, amount of pupil dilation, and sclera coloration (i.e. between healthy white to red/bloodshot).

In some embodiments of the present invention, the device 200 may include a data storage unit 208. The data storage unit 208 may be any type of non-transitory computer-readable data storage device as is known in the art, including, but not limited to, hard disk drives (HDDs), solid-state drives (SSDs), flash memory, memristor devices, and the like. The data storage 208 may be in communication with the processor 202, and the data storage 208 may be configured to receive, read, write, store, and send computer readable information/instructions that may be send to and received from the processor 202. The data storage 208 may also be in communication with the database of user records 240 and/or the user records library 242, and the data storage 208 may be configured to receive, read, write, store, and send computer readable information/instructions that may be sent to and received from the database of user records 240 and/or the user records library 242. The communication between the data storage 208 and the database of the user records 240 and/or the user records library 242 may be via the processor 202, the network controller 214, and/or the network 238.

The network controller 214 may be in communication with the processor 202 and the data storage 208. The network controller 214 may be any type of networking computer hardware known in the art capable of communicating across a network, including, but not limited to, wired network devices such as Ethernet adaptors, and wireless network devices, such as Wi-Fi adapters, Bluetooth adapters, cellular adapters, including 3G, 4G, and 5G adapters, and the like. Any type of network is contemplated and included within the scope of the invention, such as personal area networks, local area networks, and wide area networks, such as the Internet. The network controller 214 may also be in communication with the database of user records 240 and/or the user records library 242, which may be communication via the network 238. The network controller 214 may be configured to facilitate, regulate, control, and/or manage communications of computer readable instructions, information, and/or data sent to, from, and between the user records library 242, the database of user records 240, the processor 202, and the data storage 208.

Continuing to refer to FIG. 2, embodiments of the device 200 may include a power supply 244. The power supply 244 may be in communication with, and configured to supply electrical power to, the network controller 214, the processor 2012, the data storage 208, the input device(s) 204, the playback device(s) 206, and/or the monitor device(s) 210, as well as any other electrical device requiring electricity for operation comprised by the device 200.

The input device 204 may be in communication with the processor 202, the network controller 214, and the data storage 208. The input device 204 may be configured to be operable by a user to select inputs to be sent to, and received by, the processor 202, as mentioned further above for selecting a content type and an output parameter. The input device 204 may comprise a keyboard, a mouse, a joystick, a scanner, a barcode and/or QR code reader, a graphic tablet, a digitized writing pad or other surface, a trackball, a gamepad/game controller, a keypad, data input port (e.g., Universal Serial Bus (USB) port), physical gesture capture device, and/or any other input component that may be used as the input device 204 as understood by those skilled in the art. In some embodiments of the present invention, the input device 204 may include an input interface 212 having a user interface and/or graphical user interface. For example, and without limitation, the input interface 212 may comprise a display, monitor, and/or touch screen display, which may be configured to display a user interface and/or graphical user interface.

Some embodiments of the processor 202 may be configured to receive biometric data from multiple users viewing a playback of a content stream segment on the playback device(s) 206. The embodiment may include multiple monitor devices 210 to accommodate each user of the device 200, with each monitor device 210 detecting, sensing, and monitoring biometric data of a respective user and sending the biometric data of each user to be received by the processor 202. The processor 202 may receive, for example, and without limitation, a first biometric data from a first user and a second biometric data from a second user, which respectively regard the first user and the second user perceiving the output of a content stream segment on the playback device(s) 206. It is contemplated and included within the scope of the invention that biometric data from any number of users may be received by the processor 202. The processor 202 may be further configured to identify a characteristic modification of the characteristic quality of the content stream segment perceived by the first and the second users that may be responsive to both the first biometric data and the second biometric data. The processor 202 may yet further be configured to generate the following content stream segment responsive to each of content characteristic preference, the first biometric data, and the second biometric data.

The processor 202 may also be configured to receive and/or identify a weighting factor for each user of the device 200 viewing the playback of the content stream segment on the playback device(s) 206. The weighting factor may be referenced by the processor 202 to determine which of the multiple users' preferences should have higher or lower importance when identifying a characteristic modification to the characteristic quality of a content stream segment that is/was perceived by the users on the playback device(s) 206. For example, the first user may have a weighting factor of 1 while the second user may have a weighting factor of 0.5. Accordingly, the preferences of the first user will have twice the impact in determining the characteristic modification as compared to the second user. It is contemplated and included within the scope of the invention that any number of users may have an associated weighting factor.

The processor 202 may be configured to receive the weighting factor from a user selecting a weighting factor for each respective user of the device 200 via the input device 204. The processor 202 may also be configured to identify a weighting factor for each user of the device 200 with reference to user weight factors. The user weight factors may include, and without limitation, which user owns the device (the “owner”), the relationship between the other user(s) and the owner, the age of the users, the general health of the users, the gender of the users, and the user record associated with each user. The processor 202 may be configured to identify the ownership, age, health, and gender of each user via visual imagery of each user through the camera 230 of the monitor device 210, or by referencing the user record associated with each user or a user profile created by a user via the input device 204.

Referring now to FIGS. 1A-1B, additional details regarding the functions of the device 200 are now discussed. More specifically, the steps of the operation of the device 200 may comprise the steps illustrated in process 100 depicted in FIGS. 1A-1B. Starting at Block 102 and continuing to Block 104, the device 200 may receive a content request from a user, which the content request may comprise one or more content characteristic preferences. The device 200 may also receive an output parameter selection from a user. At Block 104, it may be determined by the device 200 if the content request received from the user is in the form of a natural language. If the device 200 determines that the content request received from the user is in the form of a natural language, then the device 200 may continue the process 100 to Block 106 and parse the natural language request, analyze the parsed natural language request to determine user intent, identify content characteristic preference from the user intent, and match the user intent with content type from list of content types.

If, however, at Block 104 the device 200 determines that the content request is not in the form of a natural language, then the device may continue the process 100 to Block 108 to determine if a user record is associated with the user (or users) of the device 200. This may be done, for example, by the device 200 sending a user record request to a database of user records 240 having a user records library 242 for a user record associated with the user(s). If it is determined that there is a user record associated with the user(s), then the device 200 may continue the process 100 to Block 110 and receive the user record associated with each user from the user records library 242 in database of user records 240. If, however, it is determined by the device 200 at Block 108 that there is no user record associated with the user(s), then the device 200 may continue the process 100 to Block 112 to determine if there is more than one user of the device 200.

If it is determined that there is more than one user of the device 200, then the device may continue the process 100 to Block 114 and receive or identify a weighting value for each of the users as explained further above. If, however, it is determined by the device 200 at Block 112 that there is only one user of the device 200, then the device may continue the process 100 to Block 116 to generate a first content stream segment.

Specifically referring now to FIG. 1B, the device 200 may continue the process 100 to Block 118 to output the first content stream segment via a playback device 206, and the device 200 may output sensory stimulation to the user(s) via the playback device 206. The device 200 may then continue the process 100 to Block 120 to receive biometric data regarding a user perceiving the first content stream segment on the playback device 206 from a monitoring device 210, as explained further above. The device 200 may then continue the process 100 to Block 124 to determine whether there is more than one user of the device 200. If it is determined by the device 200 that there is more than one, or a second user, of the device 200, then the device may continue the process 100 to Block 126 to receive a second (or more) biometric data set(s) regarding the second (or each for multiple) user(s) perceiving the output of the first content stream segment on the playback device 206.

The device 200 may then continue the process 100 to Block 128 to determine if the weighting value is active. This may be done by, for example, a user selecting a weighting value option on the input device 204 that is received by the processor 202 of the device 200. If it is determined by the device 200 that the weighting value is active, then the device 200 may continue the process 100 to Block 130 to receive or identify a weighting value for each user (e.g., a first and a second user) of the device 200, as detailed further above. Then the device 200 may continue the process to Block 132 to identify a characteristic modification to the first characteristic quality of the first content stream segment that was outputted on the playback device 206.

If, however, at Block 124 the device 200 determined that there is not a second user of the device 200, then the device 200 may directly continue the process 100 to Block 132 to identify a characteristic modification to the first characteristic quality of the first content stream segment that was outputted on the playback device 206. Then from Block 132, the device 200 may continue the process 100 to Block 134 to generate a second content stream segment. The device 200 may then continue the process 100 to Block 136 to output the second content stream segment on the playback device 206 and may output sensory stimulation to the user(s) via the playback device 206. Then the device 200 may continue the process 100 to Block 138 to compile a user record associated with the user(s) regarding data collected throughout the user(s) using the device 200, as detailed further above. The device 200 may then continue the process 100 to Block 140 to broadcast the user record(s) to the database of user records 240, which may be via a network 238. Then the device 200 may continue the process 100 to Block 142 to index the user record(s) with a user record library 242 in the database of user records 240. After Block 142, the device 200 may end the process 100.

Although FIGS. 1A-1B show example blocks of process 100, in some implementations, process 100 may include additional blocks, fewer blocks, different blocks, or differently arranged blocks than those depicted in FIGS. 1A-1B. Additionally, or alternatively, two or more of the blocks of process 100 may be performed in parallel.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus, the scope of the invention should be determined by the appended claims and their legal equivalents, and not by the examples given.

1. A method for generating and performing content responsive to biometric data, the steps comprising:
receiving a content request from a user comprising a content characteristic preference;
generating a first content stream segment responsive to the content characteristic preference, the first content stream segment having a first characteristic quality;
outputting the first content stream segment via a playback device;
receiving the biometric data regarding a user perceiving the output of the first segment on the playback device from at least one user monitor device;
identifying a characteristic modification to the first characteristic quality responsive to the biometric data;
generating a second content stream segment, the second content stream segment comprising content that is generated in real-time using generative artificial intelligence, responsive to each of the content characteristic preference and the biometric data in real-time, the second content stream segment having a second characteristic quality, the second characteristic quality being the result of applying the characteristic modification to the first characteristic quality; and
outputting the second content stream segment on the playback device such that the playback of the first content stream segment and the second content stream segment by the playback device are perceived by the user as a continuous content stream.

2. The method of claim 1, further comprising receiving an output parameter selection from a user selecting an output parameter from a listing of output parameters.

3. The method of claim 2 wherein the output parameter listing comprises at least one of volume, brightness, speed, data privacy, network connectivity, and time limit.

4. The method of claim 1, further comprising compiling a user record associated with the user and based upon the content characteristic preference, the first content stream segment, the biometric data, the characteristic modification, the second content stream segment, the second characteristic quality, and the continuous content stream.

5. The method of claim 4, further comprising:
broadcasting the user record to a database of user records; and
indexing the user record with a library of user records in the database of user records.

6. The method of claim 5, further comprising receiving the user record associated with the user from the library of user records in the database of user records.

7. The method of claim 1, further comprising outputting a sensory stimulation to the user that is associated with at least one of the first content stream segment and the second content stream segment.

8. The method of claim 7, wherein the sensory stimulation includes at least one of a sensation of touch, temperature, movement, or smell by the user.

9. The method of claim 1, wherein biometric data includes attributes of the user; and wherein the attributes of the user comprises at least one of the user's blood pressure, heart rate, heart rate variability (HRV), body temperature, skin temperature, flushing of skin, electrodermal activity (EDA), perspiration, breathing pattern, body movement, eye movement, facial expression, audible sound, and brain activity.

10. The method of claim 9 wherein the brain activity of the user includes the electrical activity of the brain of the user defining gamma waves, beta waves, alpha waves, theta waves, or delta waves.

11. The method of claim 1, wherein the at least one user monitor device comprises at least one of a heart monitor, a temperature monitor, a brain monitor, a breathing monitor, a camera, a microphone, a motion monitor, and a perspiration monitor.

12. The method of claim 1, wherein the content characteristic preference comprises a selection from a listing of content types, the listing of content types includes at least one of entertainment content, relaxation content, educational content, meditation content, health content, therapeutic content, relationship content, sexual content, and custom or miscellaneous content.

13. The method of claim 1, wherein the playback device comprises at least one of a visual display device and an audio generating device.

14. The method of claim 1, wherein the content request is received in the form of a selection of a content type from a list of content types, the selection defining the content characteristic preference.

15. The method of claim 1, wherein the content request is received in the form of a natural language request from the user, the method further comprising:
parsing the natural language request;
analyzing the parsed natural language request to determine a user intent; and
identifying the content characteristic preference from the user intent.

16. The method of claim 15, wherein identifying the content characteristic preference from the user intent comprises matching the user intent with a content type from a list of content types that is most closely related to the user intent.

17. The method of claim 1, wherein the biometric data is a first biometric data set related to a first user perceiving the first content stream segment, the method further comprising receiving a second biometric data set regarding a second user perceiving the output of the first segment on the playback device; wherein identifying the characteristic modification to the first characteristic quality is responsive to the first biometric data set and the second biometric data set; and wherein generating the second content stream segment is responsive to each of the content characteristic preference, the first biometric data set, and the second biometric data set.

18. The method of claim 17, further comprising receiving a weighting value for each of the first user and the second user; wherein identifying the characteristic modification to the first characteristic quality is responsive to the first biometric data set weighted by the weighting value of the first user and the second biometric data set weighted by the weighting value of the second user.

19. (canceled)

20. A device for generating and performing content responsive to biometric data comprising:
at least one processor configured to:
receive a content request from a user comprising a content characteristic preference;
generate a first content stream segment responsive to the content characteristic preference, the first content stream segment having a first characteristic quality;
output the first content stream segment via a playback device;
receive the biometric data regarding a user perceiving the output of the first segment on the playback device from at least one user monitor device;
identify a characteristic modification to the first characteristic quality responsive to the biometric data;
generate a second content stream segment, the second content stream segment comprising content that is generated in real-time using generative artificial intelligence, responsive to each of the content characteristic preference and the biometric data in real-time, the second content stream segment having a second characteristic quality, the second characteristic quality being the result of applying the characteristic modification to the first characteristic quality; and
output the second content stream segment on the playback device such that the playback of the first content stream segment and the second content stream segment by the playback device are perceived by the user as a continuous content stream.

21. The device of claim 20, wherein the at least one processor is further configured to receive an output parameter selection from a user selecting an output parameter from a listing of output parameters.

22. The device of claim 21, wherein the output parameter listing comprises at least one of volume, brightness, speed, data privacy, network connectivity, and time limit.

23. The device of claim 20, wherein the at least one processor is further configured to compile a user record associated with the user and based upon the content characteristic preference, the first content stream segment, the biometric data, the characteristic modification, the second content stream segment, the second characteristic quality, and the continuous content stream.

24. The device of claim 23, wherein the at least one processor is further configured to:
broadcast the user record to a database of user records to have the user record indexed with a library of user records in the database of user records.

25. The device of claim 24, wherein the at least one processor is further configured to receive the user record associated with the user from the library of user records in the database of user records.

26. The device of claim 20, wherein the at least one processor is further configured to output a sensory stimulation signal that is associated with at least one of the first content stream segment and the second content stream segment to be received by at least one sensory stimulation device; wherein the at least one sensory stimulation device is configured to take a sensory stimulation action based on the sensory stimulation signal received.

27. The device of claim 26, wherein the sensory stimulation action taken by the at least one sensory stimulation device includes causing a sensation of at least one of touch, temperature, movement, or smell by the user.

28. The device of claim 20, wherein biometric data includes attributes of the user; and wherein the attributes of the user comprises at least one of the user's blood pressure, heart rate, heart rate variability (HRV), body temperature, skin temperature, flushing of skin, electrodermal activity (EDA), perspiration, breathing pattern, body movement, eye movement, facial expression, audible sound, and brain activity.

29. The device of claim 28, wherein the brain activity of the user includes the electrical activity of the brain of the user defining gamma waves, beta waves, alpha waves, theta waves, or delta waves.

30. The device of claim 20, wherein the at least one user monitor device comprises at least one of a heart monitor, a temperature monitor, a brain monitor, a breathing monitor, a camera, a microphone, a motion monitor, and a perspiration monitor.

31. The device of claim 20, wherein the content characteristic preference comprises a selection from a listing of content types, the listing of content types includes at least one of entertainment content, relaxation content, educational content, meditation content, health content, therapeutic content, relationship content, sexual content, and custom or miscellaneous content.

32. The device of claim 20, wherein the playback device comprises at least one of a visual display device and an audio generating device.

33. The device of claim 20, wherein the content request is received in the form of a selection of a content type from a list of content types, the selection defining the content characteristic preference.

34. The device of claim 20, wherein the content request is received in the form of a natural language request from the user, wherein the at least one processor is further configured to:
parse the natural language request;
analyze the parsed natural language request to determine a user intent; and
identify the content characteristic preference from the user intent.

35. The device of claim 34, wherein identifying the content characteristic preference from the user intent comprises matching the user intent with a content type from a list of content types that is most closely related to the user intent.

36. The device of claim 20, wherein the biometric data is a first biometric data set related to a first user perceiving the first content stream segment;
wherein the at least one processor further configured to receive a second biometric data set regarding a second user perceiving the output of the first segment on the playback device; wherein identifying the characteristic modification to the first characteristic quality is responsive to the first biometric data set and the second biometric data set; and wherein generating the second content stream segment is responsive to each of the content characteristic preference, the first biometric data set, and the second biometric data set.

37. The device of claim 36, wherein the at least one processor is further configured to receive a weighting value for each of the first user and the second user; wherein identifying the characteristic modification to the first characteristic quality is responsive to the first biometric data set weighted by the weighting value of the first user and the second biometric data set weighted by the weighting value of the second user.

38. (canceled)

39. A method for generating and performing content responsive to biometric data, the steps comprising:
receiving a content request from a user comprising a content characteristic preference;
receiving an output parameter selection from a user selecting an output parameter from a listing of output parameters;
generating a first content stream segment responsive to the content characteristic preference and the output parameter selection, the first content stream segment having a first characteristic quality;
outputting the first content stream segment via a playback device;
receiving the biometric data regarding a user perceiving the output of the first segment on the playback device from at least one user monitor device;
identifying a characteristic modification to the first characteristic quality responsive to the biometric data;
generating a second content stream segment, the second content stream segment comprising content that is generated in real-time using generative artificial intelligence, responsive to each of the content characteristic preference, the output parameter selection, and the biometric data in real-time, the second content stream segment having a second characteristic quality, the second characteristic quality being the result of applying the characteristic modification to the first characteristic quality;
outputting the second content stream segment on the playback device such that the playback of the first content stream segment and the second content stream segment by the playback device are perceived by the user as a continuous content stream;
outputting a sensory stimulation to the user that is associated with at least one of the first content stream segment and the second content stream segment;
compiling a user record associated with the user and based upon the content characteristic preference, the first content stream segment, the biometric data, the characteristic modification, the second content stream segment, the second characteristic quality, and the continuous content stream;
broadcasting the user record to a database of user records; and
indexing the user record with a library of user records in the database of user records.
